(19) United States
(12) Patent Application Publication
(10) Pub. No.: US 2026/0164200 A1
(43) Pub. Date: Jun. 11, 2026

(54) OPEN-ENDED AUDIO TRACKING SYSTEM VIA AUDIO FOUNDATIONAL AND LARGE LANGUAGE MODELS

(71) Applicant: Robert Bosch GmbH, Stuttgart (DE)

(72) Inventors: Wei-Cheng LIN, Pittsburgh, PA (US); Luca BONDI, Pittsburgh, PA (US); Ho-Hsiang WU, Morrisville, NC (US); Shabnam GHAFFARZADEGAN, Livermore, CA (US); Abinaya KUMAR, Pittsburgh, PA (US)

(21) Appl. No.: 18/973,560

(22) Filed: Dec. 9, 2024

(51) Int. Cl. H04S 3/00

(52) U.S. Cl. CPC H04S 3/004; H04S 2400/11

(57) ABSTRACT

Methods for executing an open-ended audio tracking system are disclosed. A feedback loop between an audio foundational model (AFM) and a large language model (LLM) enables for both detection of low-level sound events in real-time and detection of high-level acoustic scenes, which are then used to generate additional text-based event descriptions that are applied in a subsequent iteration cycle of the system. The AFM may resemble a contrastive language-audio pre-training (CLAP) model that is configured to sound event detection, while the LLM receives the particular sound events that were detected and categorizes those events into an acoustic sound category that explains the environmental context of the sound events.

### TECHNICAL FIELD

The present disclosure relates to methods and systems for applying machine learning techniques to enable an audio tracking system.

### BACKGROUND

Identifying sources of acoustic content from recording devices have previously depended upon a predefined, closed set of audio classes. This severely limits the capabilities of the algorithms, since a given acoustic scene classifier is restricted to sound events that occur within the bounds of the datasets it has been trained on. These devices quickly become impractical, given the variation of sound events that occur across various acoustic scenes that a person or machine may encounter.

### SUMMARY

In an embodiment, a method for executing an open-ended audio tracking system is provided. The method includes: providing an audio segment and text-based descriptions to an Audio Foundational Model (AFM), wherein the text-based descriptions correspond to descriptions of sound events to be detected by the AFM; executing the AFM to detect a subset of the sound events that are present within the audio segment; providing the corresponding subset of text-based descriptions to a Large Language Model (LLM); executing the LLM, wherein executing the LLM comprises: classifying the audio segment into an acoustic scene category based on the detected subset of the sound events; and generating additional text-based descriptions that correspond to other descriptions of sound events that pertain to the acoustic scene category; and providing the additional text-based descriptions to be used in another iteration of executing the open-ended audio tracking system.

In another embodiment, a system including a processor and memory containing instructions that, when executed by the processor, cause the processor to perform these steps.

In another embodiment, a non-transitory computer-readable medium includes instructions that, when executed by a processor, cause the processor to perform these steps.

### BRIEF DESCRIPTION OF THE DRAWINGS

FIG. 1 illustrates a system for training and utilizing a machine learning model, such as a convolutional neural network, according to some embodiments.

FIG. 2 illustrates a computer-implemented method for training and utilizing a machine learning model, according to some embodiments.

FIG. 3 illustrates a schematic overview of an open-ended audio tracking system, according to some embodiments.

FIG. 4 illustrates a schematic overview of a Contrastive Language-Audio Pre-training (CLAP) model of the open-ended audio tracking system, according to some embodiments.

FIG. 5A illustrates an example first iteration of executing the open-ended audio tracking system, according to some embodiments.

FIG. 5B illustrates an example second iteration of executing the open-ended audio tracking system introduced in FIG. 5A, according to some embodiments.

FIG. 6 is a flow diagram that illustrates a process of executing an open-ended audio tracking system, according to some embodiments.

FIG. 7 illustrates a schematic diagram of an interaction between a computer-controlled machine and a control system, according to some embodiments.

FIG. 8 illustrates a schematic diagram of the control system of FIG. 7 configured to control an amplifier and speaker of a hearing aid device, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

There are two major techniques for identifying sources of acoustic content. A first technique is low-level sound event detection (SED), which aims to track basic elements of sounds, such as sirens, human speech, dogs barking, etc., over time. Practical applications of SED have included automatically detecting or alerting specific incidents, such as gunshots or aggression detection on security cameras. A second technique is acoustic scene classification (ASC), which focuses on a higher-level understanding of a more comprehensive acoustic environment, which may be composed of multiple sounds overlapping. Practical applications of ASC have included context awareness in smart devices or scene analysis in smart homes and cities.

However, past implementations of machine learning and modeling approaches for SED and ASC systems have depended on a predefined, closed set of audio classes. For instance, a classifier built with 10 predefined classes cannot handle any sound events outside this set. This limitation makes these models ineffective for managing the dynamic and complex audio environments encountered in the real world (e.g., from indoor to outdoor scene transitions). The primary challenge is that scaling these models requires substantial amounts of labeled data and additional retraining or adaptation processes to achieve effective performance when new sound events need to be introduced. As such, this full-loop machine learning iteration is not able to respond at anywhere close to real-time for any practical, business, or commercial needs.

To overcome these challenges, the present disclosure utilizes audio and language foundational models to engineer an open-ended audio tracking system that operates at real-time. Such foundational models enable more universal and generalized performance across various downstream tasks. More specifically, an audio foundational model (AFM), such as CLAP, enables zero-shot audio classification or retrieval through intuitive free-form natural language queries, without requiring any predefined close set. Moreover, LLMs, such as GPT-4, enable high-level reasoning, question answering, and knowledge summarization.

Rather than previous versions of AFMs which were limited to handling basic acoustic concepts, such as individual sound events, and thus lack the capacity for complex scene reasoning and summarization, the present disclosure applies a cascading architecture of AFM and LLM, which enables the open-ended audio tracking system to collaboratively perform both low-level audio signal perception and high-level acoustic scene reasoning. Thus, the open-ended audio tracking system is unrestricted in terms of either audio classes or acoustic scenes that the system may operate within. Furthermore, the model is configured to operate in real-time, thus enabling the open-ended audio tracking system to be incorporated into smart hearing aid devices and the like.

The following description continues with a general introduction to machine learning techniques that are relevant to the methods for utilizing machine learning models, such as those described herein. Next, various embodiments of the architecture and process flow of cascading AFMs and LLMs for an open-ended audio tracking system are discussed. The present disclosure then demonstrates the versatility of the methods and systems described herein for incorporation into a hearing aid device.

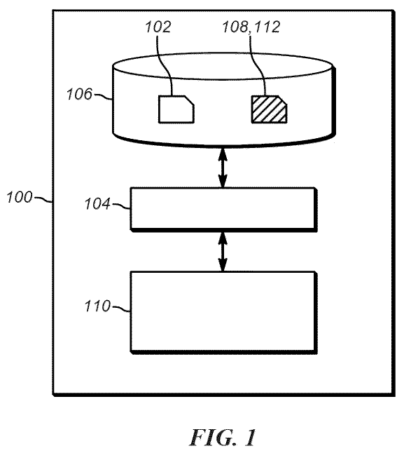

FIG. 1 illustrates a system 100 for training and utilizing a machine learning model, such as a convolutional neural network, according to some embodiments.

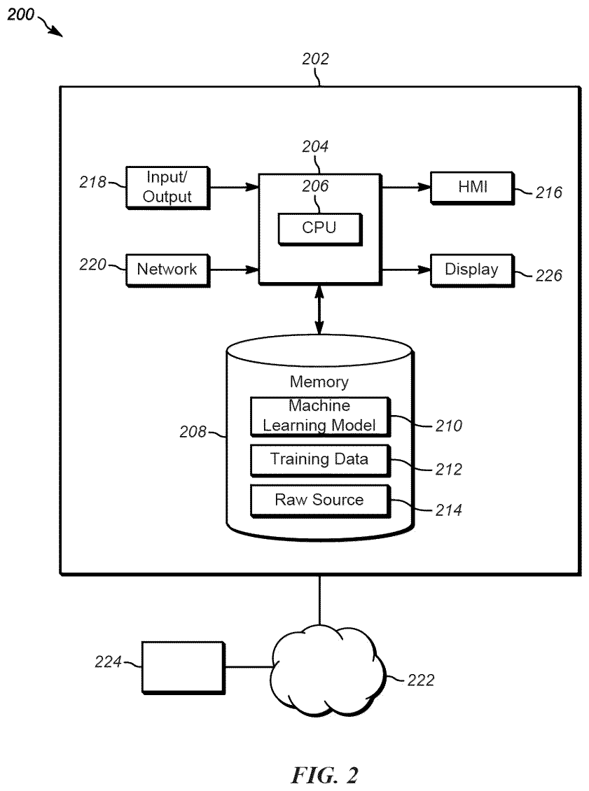

It should be understood that, while the example embodiments given in the following paragraphs herein with regard to FIGS. 1 and 2 refer to a convolutional neural network, additional embodiments of FIGS. 1 and 2 may be applied to any other type of neural-network-based or non-neural-network-based machine learning model that is configured to be developed, trained, fine-tuned, and/or executed for various applications of audio tracking and interpretation that are further described herein.

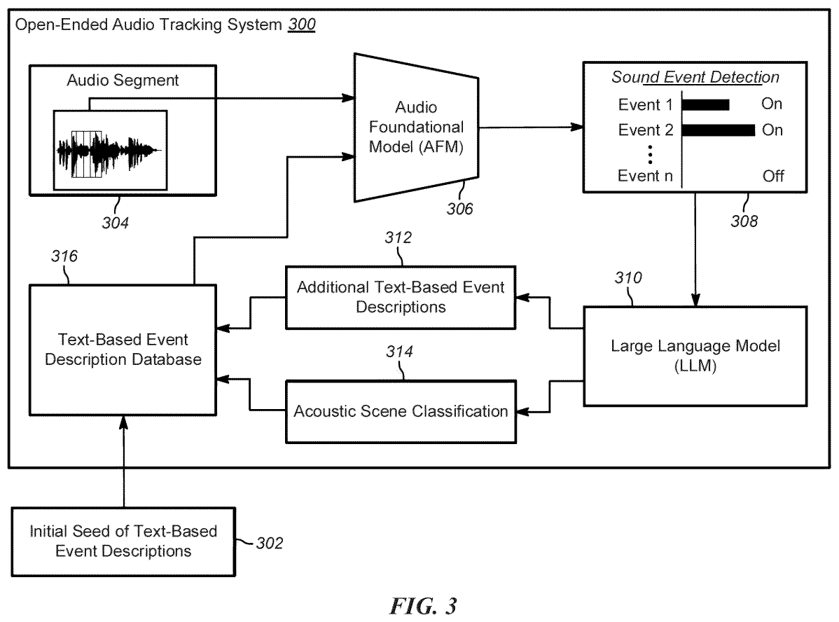

Moreover, FIGS. 1 & 2 relate to a different, earlier moment in time than moments in time illustrated in FIGS. 3-8, e.g., the fully trained open-ended audio tracking system 300, AFM 306, open-ended audio tracking system 500, and open-ended audio tracking subsystem 714. The following paragraphs describe a training process of machine learning models, such as AFMs and LLMs, such that context for the trained AFM 306 and LLM 310, for example, is thus provided. In particular, an encoder used within the architecture of the AFMs described herein are flexible, and may be configured to utilize different types of neural architecture, such as Transformers or convolutional neural networks.

In some embodiments, the system 100 may comprise an input interface for accessing training dataset 102 for the convolutional neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the pre-trained convolutional neural network may also each be accessed from a different data storage, e.g., via a different subsystem of the data storage interface 104. Each subsystem may be of a type as is described above for the data storage interface 104. In other embodiments, the data representation 108 of the pre-trained convolutional neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the convolutional neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train and/or fine-tune the convolutional neural network using the training data 102 (e.g., thus generating updated versions of the machine learning model with respect to a first “pre-trained” version of the model). Here, an iteration of the training by the processor subsystem 110 may comprise a forward propagation part and a reverse, or generation, propagation part.

The system 100 may further comprise an output interface for outputting a data representation 112 of the trained convolutional neural network, and this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘pre-trained’ convolutional neural network may during or after the training be replaced, at least in part by the data representation 112 of the trained neural network, in that the parameters of the convolutional neural network, such as weights, hyperparameters, and other types of parameters of convolutional neural networks, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘pre-trained’ convolutional neural network. In some embodiments, the output interface may be separate from the data storage interface 104, but may in general be of a type as described above for the data storage interface 104.

The system 100 shown in FIG. 1 is one example of a system that may be utilized to train and then subsequently execute the trained machine learning models described herein.

FIG. 2 illustrates a computer-implemented method for training and utilizing a convolutional neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 214, etc.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. In some examples, the machine learning algorithm 210 may be a convolutional neural network algorithm that is designed to perform a predetermined function. For example, the neural network algorithm may be configured to receive audio segments and text-based event descriptions, such as in the case of AFM 306 additionally described below.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a convolutional neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature. The raw source data 214 may be derived from a variety of sources. For example, the raw source data 214 may be actual input data collected by a machine learning system. The raw source data 214 may be machine generated for testing the system. As an example, the raw source data 214 may include audio segments and text-based event descriptions that are relevant to a nearby audio environment.

In the example, the machine learning algorithm 210 may then process raw source data 214 and output an indication of which of the text-based event descriptions are supported by audio signals within the audio segment. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

FIG. 3 illustrates a schematic overview of an open-ended audio tracking system, according to some embodiments.

As illustrated in open-ended audio tracking system 300, the framework comprises two main modules that feed one into the other: (1) AFM 306, which receives audio segments 304 and text-based event descriptions from database 316 and outputs detected sound events 308, which are then provided to (2) LLM 310. LLM 310 is configured to then process the detected sound events 308 and perform high-level acoustic scene reasoning in order to augment text-based event description database 316 with additional text-based event descriptions for a next iteration cycle of the open-ended audio tracking system 300. As the outputs of AFM 306 feed into LLM 310, which then provides outputs back to AFM 306, open-ended audio tracking system 300 is configured to operate at least at near real-time. Moreover, even when audio scenes change over time (e.g., from an indoor kitchen setting to an outdoor baseball game setting, etc.), no additional re-training of the already trained AFM 306 nor of the already trained LLM 310 is executed, based, at least in part, on the use of feedback loop described instead. As the architecture shown in FIG. 3 is training-free, open-ended audio tracking system 300 is configured to iteratively and dynamically adapt to relevant acoustic and sound scenes and events as incoming audio segments are received.

In some embodiments, AFM 306 may be implemented as a CLAP module, and may additionally be referred to herein as a CLAP4SED, or CLAP for Sound Event Detection (SED), module. CLAP may be defined as a type of contrastive learning model that compares text-based data samples with audio-based data samples. As an audio-language foundational model, CLAP is pre-trained (see also description pertaining to FIGS. 1 and 2 provided above) on audio data and corresponding language descriptions, such as audio captions, tags, or titles, using a contrastive objective, otherwise referred to herein as an objective loss.

As additionally detailed below, after providing an initial seed of text-based event descriptions 302 to AFM 306 upon a first use of open-ended audio tracking system 300, LLM 310 then augments these samples for each future iteration cycle of open-ended audio tracking system 300. Thus, the methods and systems described herein for leveraging both AFM 306 and LLM 310 for audio tracking both decreases time and resources that would otherwise be needed to train AFM 306 on specific audio environments, and also enables the unrestricted capabilities of LLMs, rather than constraining the audio tracking system to a limited language and/or audio environment.

AFM 306, when implemented as a CLAP model, may be additionally defined by the equation below, wherein this objective loss, [symbol] , aims to align the latent spaces of audio, Eₐ, and text, Eₜ, embeddings, which are mapped via modality-specific neural encoders, to establish meaningful connections between them. In some embodiments, Eₐ∈ [symbol] ^{1×D} and Eₜ∈ [symbol] ^{1×D}, wherein D represents a latent space dimension.

$$ℒ = \frac{1}{2 B} {\sum }_{B} [ log diag ( softmax ( η * ( {E}_{a} \cdot {E}_{t}^{⊤} ) ) ) + log diag ( softmax ( η * ( {E}_{t} \cdot {E}_{a}^{⊤} ) ) ) ]$$

CLAP further enables multi-directional interactions within the model. For instance, given an audio signal as input, CLAP may perform audio tagging or captioning, also referred to as “audio in, text out.” Conversely, when queried with audio and free-form natural language prompts, CLAP may be configured to perform tasks such as audio retrieval and zero-shot audio classification, also referred to as “audio and text in, recognition out.”

As such, the CLAP4SED module leverages the CLAP model for sound event detection (SED), and is configured to track the activities of specific sound events over time. Unlike conventional classification tasks, SED is configured to identify the onset and offset of the event's active temporal period. This is achieved by processing real-time audio streams in small data portions or “chunks,” which may refer to a window size of a few seconds, rather than receiving a full audio segment all at once. The CLAP model is then configured to shift forward in time an amount of a small delta buffer, or a window hop size of approximately 100-500 ms, thus collectively allowing for streaming of audio in chunks.

CLAP is further configured to compute a cosine similarity between the encoded text-based descriptions

$$( {E}_{t}^{Q} ∈ {ℝ}^{N \times D} ,$$

wherein N refers to a number of total queries in a set) and the encoded portion, or chunk, of the audio segment (Eₐ∈ [symbol] ^{1×D}) As introduced above, the text queries, or prompts, may be defined as natural language descriptions associated with sound events that may be present within the audio signals. For example, text queries may include “microwave sound,” or “wind rustling leaves.”

Once the cosine similarity between the encoded text-based descriptions and the portion of the audio segment has been computed, AFM 306 is configured to output a subset of sound events that are indeed present within the given audio portion or segment. For example, sound event detection block 308 in FIG. 3 illustrates that Event 1 was detected by the CLAP model of AFM 306 for a given temporal start and end, while Event 2 was detected for a longer temporal start and end within a total length of time defined by the given portion of audio segment 304 analyzed by AFM 306. Furthermore, Event 3 was not detected for the entire length of time defined by the given portion of audio segment 304. In some embodiments, Events 1 and 2 may also be referred to as “active” events, as computed cosine similarities were above a given threshold. Event 3, on the other hand, may also be referred to as an “inactive” event, as the computed cosine similarity was below the given threshold.

The analysis information within sound event detection block 308 is then provided to LLM 310. In some embodiments, the subset of text-based descriptions that correspond to the active events that were present within the audio portion or segment are provided to LLM 310 in a structured or natural text format. For example, and continuing with the particular illustration shown in sound event detection block 308, the analysis may be provided to LLM 310 in a JSON format, such as [{‘label’:‘event1’, ‘start’:1.2, ‘end’:4.5},{‘label’:‘event2’, ‘start’:3.0, ‘end’:6.5}]. This structured format indicates that AFM 306 detected the sound of Event 1 starting at 1.2 and ending at 4.5 seconds and Event 2 starting at 3.4 and ending at 6.5 seconds. This process enables for low-level sound event tracking, based on the text-based event descriptions that are augmented, as additionally described in the following paragraphs, over time.

As additionally illustrated in FIG. 3, LLM 310 is configured to receive the subset of text-based descriptions that correspond to active sound events, output (1) an acoustic scene classification 314, and generate (2) additional text-based event descriptions 312. In some embodiments, LLM 310 may be implemented as a Generative Pre-trained Transformer (GPT) LLM, such as ChatGPT. However, LLM 310 may, in other embodiments, be implemented as any other large language model that is configured to receive the subset of text-based descriptions that correspond to active sound events, output (1) an acoustic scene classification 314, and generate (2) additional text-based event descriptions 312.

The first of the two outputs provides a summary of a high-level acoustic scene from which the LLM has deduced that the subset of text-based descriptions likely comes from. This classification defines an acoustic scene category, such as “kitchen,” or “neighborhood park,” or some other descriptive language based on the sound event detection block 308.

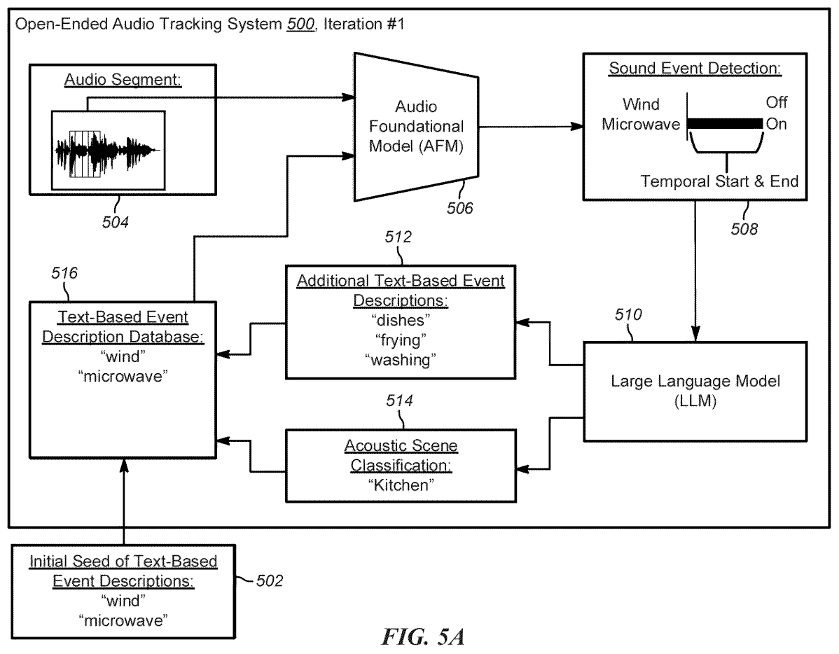

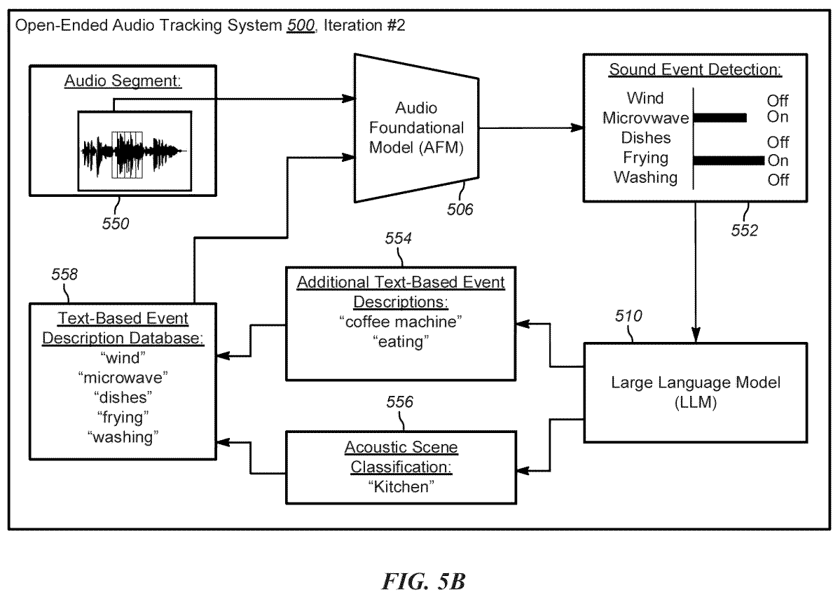

Acoustic scene categories may include any high-level description of a local environment. Additional examples of classifications of acoustic scene categories are provided in FIGS. 5A and 5B, and the related description herein.

In some embodiments, one or more prompts may be generated and provided to LLM 310 in order to perform this functionality. For example, a first prompt may be to determine a likely local environment of the audio segment based on the detected subset of the sound events provided to the LLM. A second prompt or instruction may be to augment the detected subset of the sound events, as additionally described in the following paragraphs.

The second of the two outputs, namely the additional text-based event descriptions 312, refers to an augmentation of an existing list of text-based event descriptions already stored in database 316. For example, if database 316 already has some text-based descriptions related to a neighborhood park acoustic scene, such as “kids laughing” and “ice cream truck,” LLM 310 may be configured to augment the possible sound events that may be identified by AFM 306 when provided with an audio segment of the neighborhood park acoustic scene, such as “dog barking” and “swing set noise.” Additional examples of augmenting the text-based event descriptions are provided in FIGS. 5A and 5B, and the related description herein.

These additional text-based event descriptions 312 and acoustic scene classification 314 are then stored into text-based event description database 316, and subsequently provided to AFM 306 during the next iteration cycle of open-ended audio tracking system 300. Thus, from one iteration cycle to the next, open-ended audio tracking system 300 resembles a self-adaptive method for identifying both a more comprehensive audio tracking framework and a more detailed audio tracking framework.

In some embodiments, the additional text-based event descriptions 312 may be labeled as corresponding to being present in the acoustic scene category 314, prior to being stored into text-based event description database 316. For example, and continuing with the example introduced above, “dog barking” and “swing set noise” may be labeled as occurring in a neighborhood park acoustic scene.

Moreover, LLM 310 may additionally be configured to detect a false positive as having occurred during the detection of sound events present in the audio segment by AFM 306, according to some embodiments. In particular, a given false positive sound event may be determined to not likely to correspond to an aggregate local environment of other sound events within the subset of sound event detections received by LLM 310. In such cases, the false positive is removed from the subset of the sound events prior to storing any additional sound events into text-based event description database 316. For example, and continuing with the example introduced above, if “kids laughing,” “ice cream truck,” and “kitchen blender” are text-based descriptions that are detected by AFM 306 and provided as part of sound event detection block 308 to LLM 310, then LLM 310 may determine that “kitchen blender” is a false positive sound event of the subset, as the aggregate local environment of the other sound events are likely to indicate that audio segment 304 refers to a neighborhood park.

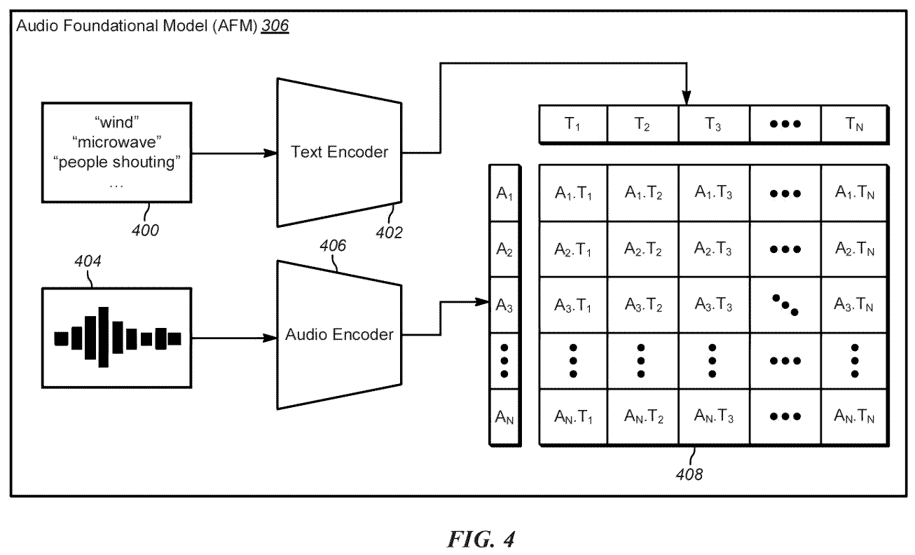

FIG. 4 illustrates a schematic overview of a CLAP model of the open-ended audio tracking system, according to some embodiments.

In some embodiments, AFM 306 may be implemented and executed as a CLAP model, and by utilizing one or more components of the system 200, such as computing system 202. AFM 306 receives, as input, both text-based data samples 400 and a portion 404 of an audio segment, in pairs. Each text input can be a word, a phrase, or a sentence that is linked or paired with an associated audio signal that is expected to possibly be present within the segment. For example, text inputs can be “wind,” “microwave,” “people shouting,” etc., which are text-based event descriptions that may be present in the current audio segment 304 or may have been present in a previously received audio segment.

A CLAP implementation of AFM 306 leverages contrastive learning to generate a joint multimodal space for audio and text descriptions. CLAP takes audio and text pairs, processes them through separate encoders, and brings their representations into a joint space using linear projections. In particular, CLAP uses two encoders—a text encoder 402 and an audio encoder 406—to connect language and audio representations. This method aims to enable zero-shot predictions without the need for predefined categories during either training or execution of the model. Both representations are connected in joint multimodal space with linear projections. The space is learned with the (dis)similarity of audio and text pairs in a batch using contrastive learning, shown generally at 408.

In general, the contrastive learning, illustrated in FIG. 4, may be performed as follows. Initially, both the text data 400 and the audio data 404 are processed separately through dedicated encoders, resulting in text embeddings and audio embeddings, respectively. These embeddings capture essential features or representations of the respective data. Several irrelevant or dissimilar text phrases and audio segments can also be fed into the encoders. The embeddings are projected into a joint space using learnable linear projections. This joint space is where the audio and text representations are compared and aligned. In the example shown, a text encoder 402 produces a text-based vector having features T₁, T₂, T₃, . . . , T_{N}, while an audio encoder 406 produces an audio-based vector having features A₁, A₂, A₃, . . . , A_{N}.

Once the embeddings are in the joint space, the model computes the similarity between the embeddings of audio-text pairs. Similarity can be measured using various metrics, such as cosine similarity or Euclidean distance. For instance, the model might assess how close or far apart the audio representation and its corresponding text representation are in this joint space. Contrastive learning employs a loss function that encourages the model to bring similar pairs closer while pushing dissimilar pairs apart. It calculates a loss based on the similarity between positive pairs (pairs of audio and text belonging together) and negative pairs (pairs that do not correspond to each other). This encourages the model to learn representations that make similar pairs more distinguishable from dissimilar pairs. The diagonal of the resulting matrix 408 from this dot product shows paired audio and text according to their likely similarity, while the off-diagonal represents unpaired text and audio features (e.g., the sound of a person yelling and text sample stating “a person is whispering”). Thus, the goal of the contrastive learning method of AFM 306, when implemented as a CLAP model, is to minimize this contrastive loss by adjusting the model's parameters, such as the encoders and projection layers. CLAP is able to then learn to capture meaningful relationships between audio and text representations, effectively learning to associate relevant textual descriptions with corresponding audio signals.

FIGS. 5A and 5B illustrate example first and second iteration cycles, respectively, of executing the open-ended audio tracking system, according to some embodiments.

As introduced above with regard to FIG. 3 and open-ended audio tracking system 300, open-ended audio tracking system 500 illustrates additional embodiments in which the framework includes AFM 506 and LLM 510 that operate in a feedback loop with one another. In the description that follows, FIG. 5A may be treated as a first iteration cycle of open-ended audio tracking system 500, wherein text-based event description database 516 is considered to be empty at a moment just prior to the moment in time depicted in FIG. 5A. FIG. 5B may then be treated as the immediately subsequent, or second, iteration cycle of open-ended audio tracking system 500.

As illustrated in FIG. 5A, an initial seed of text-based event descriptions 502 is provided to text-based event description database 516 of open-ended audio tracking system 500. In some embodiments, an initial seed 502 may include a small number of initial text-based event descriptions that the open-ended audio tracking system 500 will begin tracking for. It should be understood that “wind” and “microwave” are meant to be illustrative examples, and that a larger or smaller number of initial text-based event descriptions may be used. Furthermore, the initial seed 502 may refer to single words, phrases, or sentences that describe event sounds in various acoustic scenes. Moreover, text-based descriptions may refer herein to descriptions of sound events caused by humans, animals, machines, or other nature-based events (e.g., wind, thunder, rain, etc.).

A first portion 504 of the given audio segment, along with the text-based event descriptions within database 516 are then provided to AFM 506, which encodes the first portion of audio segment 504 into an audio embedding and encodes the text-based event descriptions within database 516 into a text embedding. In embodiments in which AFM 506 is implemented as a CLAP model, the embeddings are used to compute cosine similarities between the respective embeddings in order to determine which, if any, sound events that correspond to the text-based event descriptions within database 516 are present within the first portion 504 of the given audio segment.

As illustrated in the particular embodiments shown in sound event detection block 508 of FIG. 5A, “microwave” was detected for a given temporal start and end, while “wind” was not detected at all for the duration of the temporal length of the first portion 504 of the given audio segment.

The temporal start and end of “microwave,” along with the text-based event description itself, “microwave,” are then provided to LLM 510. The execution of LLM 510 then includes a determination that the acoustic scene classification 514 of the first portion 504 of the given audio segment is “kitchen,” based on learning that a microwave sound was detected.

The execution of LLM 510 additionally includes a generation of various other additional text-based event descriptions 512 that correspond to other sound events that may also be present within a “kitchen” acoustic scene classification 514. As illustrated in the particular embodiments shown in additional text-based event descriptions 512, “dishes,” “frying,” and “washing,” are generated and output by LLM 510.

The additional text-based event descriptions 512 are then stored into text-based event description database 516 with their labels of a “kitchen” acoustic scene classification.

The first iteration cycle of open-ended audio tracking system 500 is thus complete, and the system 500 continues in a loop with providing another round of text-based event descriptions and a second portion of the given audio segment to AFM 506, as shown in FIG. 5B.

In FIG. 5B, a second portion 550 of the given audio segment, along with the text-based event descriptions within database 558, wherein the database 558 refers to an updated version of database 516 with additional text-based event descriptions 512 already stored inside, are then provided to AFM 506, which then encodes the second portion 550 of the given audio segment into an audio embedding and encodes the text-based event descriptions within database 558 into a text embedding. In embodiments in which AFM 506 is implemented as a CLAP model, the embeddings are used to compute cosine similarities between the respective embeddings in order to determine which, if any, sound events that correspond to the text-based event descriptions within database 558 are present within the second portion 550 of the given audio segment.

As illustrated in the particular embodiments shown in sound event detection block 552 of FIG. 5B, “microwave” was detected for a given temporal start and end and “frying” was detected for another given temporal start and end, while “wind” was not detected at all for the length of the second portion 550 of the given audio segment, nor was “dishes” or “washing.”

The temporal start and end of “microwave,” along with the text-based event description itself, “microwave,” and the temporal start and end of “frying,” along with the text-based event description itself, “frying” are then provided to LLM 510. The execution of LLM 510 then includes a determination that the acoustic scene classification 556 of the second portion 550 of the given audio segment is still “kitchen,” based on learning that a microwave sound and a frying sound were detected.

The execution of LLM 510 additionally includes a generation of various other additional text-based event descriptions 554 that correspond to yet still more sound events that may also be present within a “kitchen” acoustic scene classification 556. As illustrated in the particular embodiments shown in additional text-based event descriptions 554, “coffee machine” and “eating” are generated and output by LLM 510.

The additional text-based event descriptions 554 are then stored into text-based event description database 558 with their labels of a “kitchen” acoustic scene classification.

The second iteration cycle of open-ended audio tracking system 500 is thus complete, and the system 500 continues in a loop with providing another round of text-based event descriptions and a third portion of the given audio segment to AFM 506, and so on.

At a later moment in time, when “wind” text-based event description is detected using AFM 506, LLM 510 may change the acoustic scene classification, such as to “city street,” or some other outdoor scene classification. Thus, the corresponding additional text-based event descriptions may then include sound events associated with “city street,” such as “dog barking,” “car passing,” “bird chirping,” and so on.

As the AFM and the LLM have already been pre-trained, then even when an acoustic scene classification drastically changes (e.g., from “kitchen” to “city street”), open-ended audio tracking system 500 is configured to dynamically adapt to various scenarios as they are introduced. No additional retraining occurs, and open-ended audio tracking system 500 is self-contained (e.g., no human intervention).

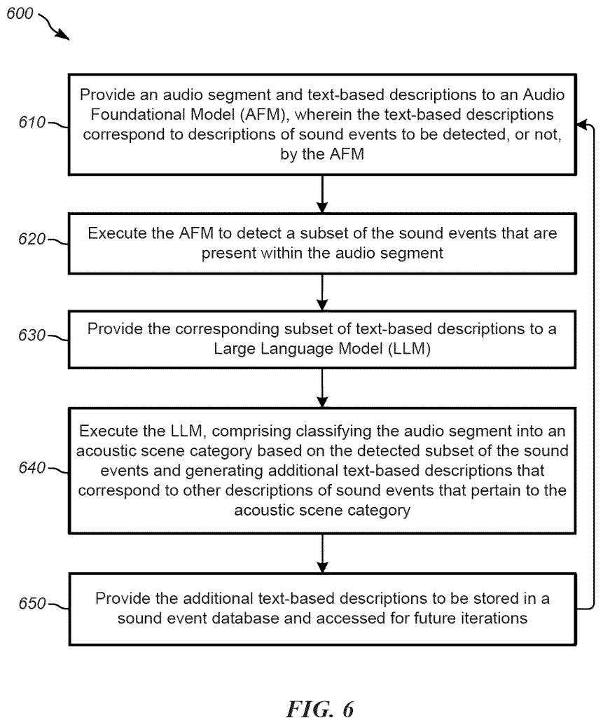

FIG. 6 is a flow diagram that illustrates a process of executing an open-ended audio tracking system, according to some embodiments. In some embodiments, process 600 may be used to describe a given iteration cycle of open-ended audio tracking system 300. Process 600 may then be repeated, as indicated by the arrow between blocks 650 and 610, and as further described above with regard to iteration #1 and #2 of open-ended audio tracking system 500.

In block 610, an audio segment, or a portion of an audio segment, along with text-based descriptions from a text-based sound event description database, are provided to an AFM, such as CLAP. The text-based descriptions correspond to sound events that are to be detected, or not, by CLAP using a cosine similarity computation.

In block 620, the AFM is executed in order to detect one or more sound events that are present within the audio segment, wherein the one or more sound events come from the set of text-based descriptions described in block 610.

In block 630, the subset of text-based descriptions are then provided to an LLM, which, as illustrated in block 640, is configured to classify the audio segment into an acoustic scene category and generate additional text-based descriptions that pertain to descriptions of other potential sound events that could take place within that acoustic scene category.

In block 650, the additional text-based descriptions are stored in a sound event database and accessed for future iterations when providing text-based descriptions and audio segments to the AFM for another iteration cycle of the open-ended audio tracking system.

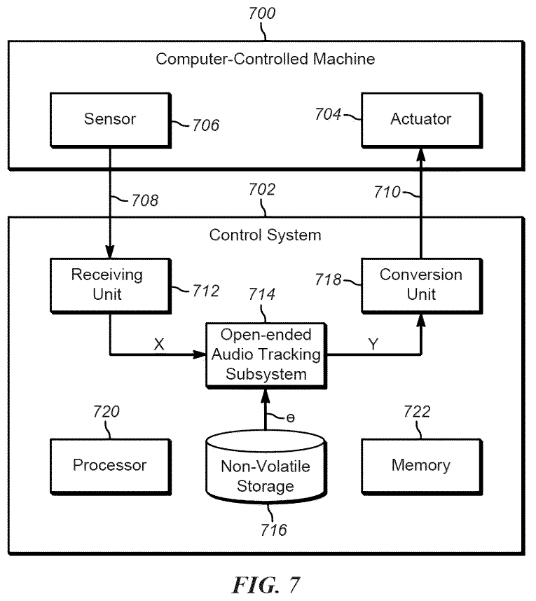

FIG. 7 illustrates a schematic diagram of an interaction between a computer-controlled machine and a control system, according to some embodiments.

The methods and systems disclosed herein can be used in many different applications. This section provides some practical applications of the proposed system.

As a first example, an open-ended audio tracking system may be implemented into a context-aware smart device. An open-ended acoustic scene detection system may be integrated into existing edge hardware devices, thus providing extra context-awareness features to facilitate automatic smart decisions. For instance, hearing aid devices often require users to manually adjust microphone settings to achieve the best experience [2]. However, this ad-hoc tuning can pose additional challenges for elderly or children users who may struggle to remember and manage different configurations. An integrated open-ended acoustic scene detection system can automatically adjust pre-set configurations based on the detected scene, thereby providing an optimized user experience.

As a first example, an open-ended audio tracking system may track both low-level and high-level audio contents in near real-time, or real-time, offering comprehensive audio analytics solutions. In a given instance, the open-ended audio tracking system enables for querying audio tracking results with and LLM for tasks such as audio-based question-answering to locate specific events, reasoning about sequence of events, or retrieving information on anomalies over time. It can also be utilized to monitor critical events, such as gunshots and aggression, on security cameras.

As a second example, an open-ended audio tracking system may be implemented into a context-aware smart device. An open-ended acoustic scene detection system may be integrated into existing edge hardware devices, thus providing extra context-awareness features to facilitate automatic smart decisions. For instance, previous implementations of hearing aid devices would often require that users to manually adjust microphone settings to achieve the best experience when moving between different types of acoustic scenes. However, this ad-hoc tuning can pose additional challenges for the elderly or for users that are children, and thus may struggle to remember and manage different configurations, especially in a timely manner so as not to miss cues from their different environments. An integrated open-ended acoustic scene detection system, on the other hand, can automatically adjust pre-set configurations based on the detected acoustic scene, thereby providing a more optimized user experience. Hearing aid device 800 and the description below provides additional examples of such an integration.

FIG. 7 depicts a schematic diagram of an interaction between a computer-controlled machine 700 and a control system 702. Computer-controlled machine 700 includes actuator 704 and sensor 706. Actuator 704 may include one or more actuators and sensor 706 may include one or more sensors. Sensor 706 is configured to sense a condition of computer-controlled machine 700. Sensor 706 may be configured to sense ID and/or OOD data, and the corresponding processors can be configured to determine whether the data is ID or OOD according to the teachings herein. Sensor 706 may be configured to encode the sensed condition into sensor signals 708 and to transmit sensor signals 708 to control system 702. Non-limiting examples of sensor 706 include a microphone, a camera, video sensor, optical sensor, and the like. In one embodiment, sensor 706 is a microphone that is configured to receive audio signals of an environment proximate to computer-controlled machine 700.

Control system 702 is configured to receive sensor signals 708 from computer-controlled machine 700. As set forth below, control system 702 may be further configured to compute actuator control commands 710 depending on the sensor signals and to transmit actuator control commands 710 to actuator 704 of computer-controlled machine 700.

As shown in FIG. 7, control system 702 includes receiving unit 712. Receiving unit 712 may be configured to receive sensor signals 708 from sensor 706 and to transform sensor signals 708 into input signals x. In an alternative embodiment, sensor signals 708 are received directly as input signals x without receiving unit 712. Each input signal x may be a portion of each sensor signal 708. Receiving unit 712 may be configured to process each sensor signal 708 to product each input signal x. Input signal x may include data corresponding to an image recorded by sensor 706. For example, image-based data samples and text-based data samples may be received to receiving unit 712.

Control system 702 includes an open-ended audio tracking subsystem 714. Open-ended audio tracking subsystem 714 may be configured to detect sound events within audio signals received by sensor 706. Open-ended audio tracking subsystem 714 is configured to be parametrized by parameters, such as those described above (e.g., parameter θ). Parameters θ may be stored in and provided by non-volatile storage 716. Open-ended audio tracking subsystem 714 is configured to determine output signals y from input signals x. Each output signal y includes information that assigns one or more labels to each input signal x. Open-ended audio tracking subsystem 714 may transmit output signals y to conversion unit 718. Conversion unit 718 is configured to covert output signals y into actuator control commands 710. Control system 702 is configured to transmit actuator control commands 710 to actuator 704, which is configured to actuate computer-controlled machine 700 in response to actuator control commands 710. In another embodiment, actuator 704 is configured to actuate computer-controlled machine 700 based directly on output signals y.

Upon receipt of actuator control commands 710 by actuator 704, actuator 704 is configured to execute an action corresponding to the related actuator control command 710. Actuator 704 may include a control logic configured to transform actuator control commands 710 into a second actuator control command, which is utilized to control actuator 704. In one or more embodiments, actuator control commands 710 may be utilized to control a display instead of or in addition to an actuator.

In another embodiment, control system 702 includes sensor 706 instead of or in addition to computer-controlled machine 700 including sensor 706. Control system 702 may also include actuator 704 instead of or in addition to computer-controlled machine 700 including actuator 704.

As shown in FIG. 7, control system 702 also includes processor 720 and memory 722. Processor 720 may include one or more processors. Memory 722 may include one or more memory devices. The open-ended audio tracking subsystem 714 of one or more embodiments may be implemented by control system 702, which includes non-volatile storage 716, processor 720 and memory 722.

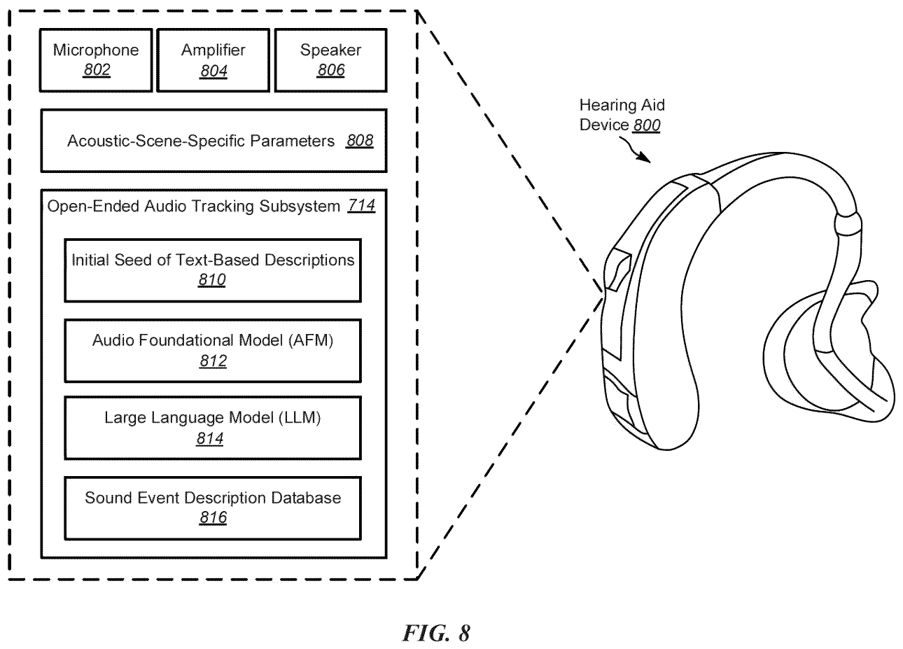

Non-volatile storage 716 may include one or more persistent data storage devices such as a hard drive, optical drive, tape drive, non-volatile solid-state device, cloud storage or any other device capable of persistently storing information. Processor 720 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 722. Memory 722 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 720 and memory 722 may be configured to provide collected data to one or more other computing devices that are configured to execute the open-ended audio tracking subsystem within domain-specific embodiments that are also shown in FIG. 8. Such collected data may be used to generate training datasets and validation datasets for various stages in preparing and executing a machine learning model into industry-grade applications. Within a context described herein with regard to executing an open-ended audio tracking system, processor 720 and memory 722 may be coupled to or otherwise remotely connected to computing devices that may then conduct audio tracking processes such as those described above.

Processor 720 may be configured to read into memory 722 and execute computer-executable instructions residing in non-volatile storage 716 and embodying one or more machine learning algorithms and/or methodologies of one or more embodiments. Non-volatile storage 716 may include one or more operating systems and applications. Non-volatile storage 716 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 720, the computer-executable instructions of non-volatile storage 716 may cause control system 702 to implement one or more of the machine learning algorithms and/or methodologies as disclosed herein. Non-volatile storage 716 may also include machine learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 8 illustrates a schematic diagram of the control system of FIG. 7 configured to control an amplifier and speaker of a hearing aid device, according to some embodiments.

In some embodiments, open-ended audio tracking subsystem 714 may be incorporated into hearing aid device 800. As illustrated in FIG. 8, hearing aid device 800 may comprise a sensor, such as microphone 802, which is configured to detect audio signals from an environment surrounding the hearing aid device 800. The detected audio signals are then provided to open-ended audio tracking subsystem 714 of control system 702, wherein audio segments of the audio signals, along with various text-based event descriptions, are provided to AFM 812. AFM 812 is then executed to detect some subset of the sound events that are present within the given audio segment.

The subset of the sound events are then provided to LLM 814, which classifies the audio segment into an acoustic scene category based on the detected subset of the sound events, and generates additional text-based descriptions that correspond to other descriptions of sound events that pertain to the acoustic scene category that was classified. The additional text-based descriptions are then stored in sound event description database 816.

In some embodiments, the control system 702 may then be configured to provide the classification of the acoustic scene, such that the control system extracts, from the memory of the device, pre-defined parameters from acoustic-scene-specific parameters 808 that pertain to usage of the hearing aid device within an environment that matches the acoustic scene category, and then provide those pre-defined parameters to the receiver of hearing aid device 800, e.g., amplifier 804 and, by extension, speaker 806.

In other embodiments, the control system 702 may then be configured to update a signal-to-noise ratio based on the detected subset of the sound events, and provide the updated signal-to-noise ratio to amplifier 804 and speaker 806.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A hearing aid device, comprising:
a microphone, configured to detect audio signals;
a processor; and
memory storing program instructions that, when executed by the processor, cause the processor to:
receive an audio signal from the microphone;
provide an audio segment of the audio signal and text-based descriptions to an Audio Foundational Model (AFM), wherein the text-based descriptions are stored in the memory and correspond to descriptions of sound events to be detected by the AFM;
execute the AFM to detect a subset of the sound events that are present within the audio segment;
provide the corresponding subset of text-based descriptions to a Large Language Model (LLM);
execute the LLM, wherein the execution of the LLM comprises:
classify the audio segment into an acoustic scene category based on the detected subset of the sound events; and
generate additional text-based descriptions that correspond to other descriptions of sound events that pertain to the acoustic scene category; and
provide the additional text-based descriptions to be used in executing another iteration of the AFM with another audio segment.

2. The hearing aid device of claim 1, wherein the program instructions further cause the processor to:
update a signal-to-noise ratio, based on the detected subset of the sound events; and
provide the updated signal-to-noise ratio to speaker of the hearing aid device.

3. The hearing aid device of claim 1, wherein the program instructions further cause the processor to:
extract, from the memory, pre-defined parameters that pertain to usage of the hearing aid device within the acoustic scene category; and
provide the pre-defined parameters to a receiver of the hearing aid device.

4. The hearing aid device of claim 1, wherein the program instructions further cause the processor to:
provide the additional text-based descriptions to be stored in the memory; and
responsive to reception of another audio segment, provide the text-based descriptions, the additional text-based descriptions, and the other audio segment to the AFM for execution.

5. The hearing aid device of claim 4, wherein, when providing the additional text-based descriptions to be stored in the memory, the program instructions further cause the processor to label the additional text-based descriptions as corresponding to being present in the acoustic scene category.

6. The hearing aid device of claim 1, wherein the text-based descriptions that correspond to descriptions of sound events comprise descriptions of sounds caused by humans, animals, or machines.

7. The hearing aid device of claim 1, wherein the acoustic scene category comprises a high-level description of a local environment of the hearing aid device for a duration of the audio segment.

8. A computer-implemented method for executing an open-ended audio tracking system, the method comprising:
providing an audio segment and text-based descriptions to an Audio Foundational Model (AFM), wherein the text-based descriptions correspond to descriptions of sound events to be detected by the AFM;
executing the AFM to detect a subset of the sound events that are present within the audio segment;
providing the corresponding subset of text-based descriptions to a Large Language Model (LLM);
executing the LLM, wherein executing the LLM comprises:
classifying the audio segment into an acoustic scene category based on the detected subset of the sound events; and
generating additional text-based descriptions that correspond to other descriptions of sound events that pertain to the acoustic scene category; and
providing the additional text-based descriptions to be used in another iteration of executing the open-ended audio tracking system.

9. The computer-implemented method of claim 8, further comprising:
providing the additional text-based descriptions to be stored in an event description database; and
responsive to receiving another audio segment, providing the text-based descriptions, the additional text-based descriptions, and the other audio segment to the AFM for execution.

10. The computer-implemented method of claim 9, further comprising:
prior to providing the additional text-based descriptions to be stored in the event description database, labeling the additional text-based descriptions as corresponding to being present in the acoustic scene category.

11. The computer-implemented method of claim 8, wherein the executing the AFM comprises:
encoding the text-based descriptions;
encoding portions of the audio segment;
computing a cosine similarity between the encoded text-based descriptions and the encoded portions of the audio segment; and
determining that a given sound event is present within the audio segment when the corresponding cosine similarity is above a threshold.

12. The computer-implemented method of claim 11, wherein the executing the AFM further comprises:
determining a temporal start and end to the given sound event; and
additionally providing the temporal start and end to the LLM for execution.

13. The computer-implemented method of claim 8, wherein the AFM is a Contrastive Language-Audio Pre-training (CLAP) model.

14. The computer-implemented method of claim 8, further comprising generating prompts to provide to the LLM for execution, wherein the prompts comprise:
a first instruction to determine a likely local environment of the audio segment based on the detected subset of the sound events provided; and
a second instruction to augment the detected subset of the sound events.

15. The computer-implemented method of claim 8, wherein the executing the LLM further comprises:
detecting a false positive among the subset of the sound events based on determining that the false positive sound event is not likely to correspond to an aggregate local environment of other sound events within the subset; and
prior to storing the subset of the sound events into an event description database, removing the false positive.

16. The computer-implemented method of claim 8, wherein the LLM is a Generative Pre-trained Transformer (GPT) LLM.

17. A non-transitory, computer-readable medium storing program instructions that, when executed on or across a processor, cause the processor to:
provide an audio segment and text-based descriptions to an Audio Foundational Model (AFM), wherein the text-based descriptions correspond to descriptions of sound events to be detected by the AFM;
execute the AFM to detect a subset of the sound events that are present within the audio segment;
provide the corresponding subset of text-based descriptions to a Large Language Model (LLM);
execute the LLM, wherein the execution of the LLM comprises:
classification of the audio segment into an acoustic scene category based on the detected subset of the sound events; and
generation of additional text-based descriptions that correspond to other descriptions of sound events that pertain to the acoustic scene category; and
provide the additional text-based descriptions to be used in another iteration of execution of the AFM with another audio segment.

18. The non-transitory, computer-readable medium of claim 17, wherein, to cause the AFM to be executed, the program instructions cause the processor to:
encode the text-based descriptions;
encode portions of the audio segment;
compute a cosine similarity between the encoded text-based descriptions and the encoded portions of the audio segment; and
determine that a given sound event is present within the audio segment when the corresponding cosine similarity is above a threshold.

19. The non-transitory, computer-readable medium of claim 18, wherein, to execute the AFM, the program instructions further cause the processor to:
determine a temporal start and end to the given sound event; and
additionally provide the temporal start and end to the LLM for execution.

20. The non-transitory, computer-readable medium of claim 17, wherein, to execute the LLM, the program instructions further cause the processor to:
detect a false positive among the subset of the sound events based on a determination that the false positive sound event is not likely to correspond to an aggregate local environment of other sound events within the subset; and
prior to causing the subset of the sound events to be stored into an event description database, remove the false positive.
